(19) United States
(12) Patent Application Publication
(10) Pub. No.: US 2005/0022013 A1
(43) Pub. Date: Jan. 27, 2005

(54) Method for customized data output on a web site

(76) Inventor: Joerg Schwenk, Bad Sassendorf (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/491,596

(22) PCT Filed: Sep. 7, 2002
(86) PCT No.: PCT/DE02/03321

(30) Foreign Application Priority Data
Oct. 4, 2001 (DE) 101 48 985.4

(51) Int. Cl. G06F 17/60; H04L 9/32; G06F 11/30

(52) U.S. Cl. 713/201; 705/14

(57) ABSTRACT

In a method for customized data output on a web site, whereby specific data can be added to the content of a web site in targeted manner for an Internet user or a specific group of persons, a list of preferences is filed for the user in a databank of his Internet service provider (ISP), for example under his client number. When the user calls a web site, the web server contacted by the user requests the preferences from the ISP. The server transmits to the databank server, on querying the databank, the temporary IP address from which the web site has been called. The databank server accesses through an inverse a reverse RADIUS request the user's preferences and transmits them to the web servers which uses the preferences to add to the called web site the customized data corresponding to the preferences

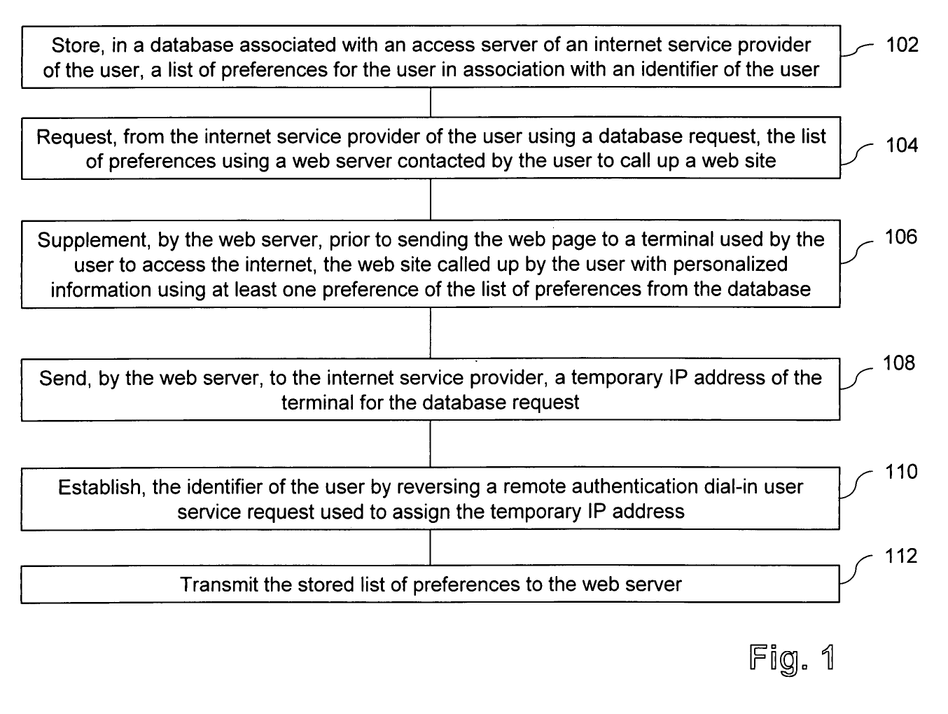

The present invention relates to a method for outputting personalized information on a web site, whereby specific information can be selectively added to the content of a web site for an Internet user of a defined group of persons.

It is presently known to send Internet users advertising messages in the form of advertising banners that are displayed on an Internet page, or to transmit these messages by opening a new browser window. While initially these and other information contents were static or undifferentiated, today there are already methods that allow advertising banners to be displayed depending on the customer group. A way to do this is to differentiate Internet users by countries and/or language regions. Thus, for example, on an American web site, that is, on a page maintained under the “US” Internet top level domain, it is possible to selectively display German-language advertising for an Internet user calling the page from the German-speaking area. This is accomplished by identifying the IP subnet in the Internet address of the client calling the page, which is transmitted the respective web server. The IP address arriving at the server can be associated with a country or (in the case of domains such as net or .org) with an Internet service provider (ISP) via the subnet determined.

A further possibility is the already widespread use of so-called “cookies”. In the process, a web server can leave a value in the cookie file of a browser used by the user; this value allowing the web server to recognize the browser when it is accessed again at a later time. However, the use of the cookie is limited to the respective web server. As far as is known, there is no standard format for cookies. At least in the first-mentioned solution, it is not possible to personalize web pages down to the level of the individual user. In addition, both solutions operate without the assistance of the user, and therefore essentially do not allow user intervention (apart from the possibility to disable the use of cookies via the browser, but to thereby also refrain from using part of the web contents). In many cases, advertising is therefore perceived as disturbing or annoying. This is why there are already programs that make it possible to block advertising banners on the Internet pages, or to remove them when displayed. On the other hand, there are certain contents that the user (customer) may indeed be interested in, but which are also blocked when using the programs mentioned above. However, beyond the possibility of advertising, there is also a general need to supplement web sites with information contents that are specifically tailored to one or more specific users.

It is an object of the present invention to provide a method which allows personalized information to be output on a web site called up by an Internet user while avoiding the disadvantages of the methods mentioned above. In particular, the intention is to allow personalization down to the level of the individual Internet user. Advantageously, the method is also designed to allow the user himself/herself to influence which additional information is offered to him/her.

This objective is achieved by a method having the features of the main claim. According to the present invention, to output personalized information on a web site called up by an Internet user (user), a list of preferences (preference list), preferably of personal interests of the user, is stored for the user in association with an identifier, such as the customer number or the like, in a database associated with the access server of the user's Internet service provider (ISP). When the user calls up a web site, the contacted web server requests these preferences from the ISP via a database request. To this end, the contacted web server establishes a connection to the database server of the ISP and, while making the database request, sends the database server the temporary IP address from where the web site was called up. At the ISP, the database server, which is implemented directly on the access server or associated therewith, establishes an identifier of the user, such as the customer number, by reversing the Remote Authentication Dial-In User Service request (RADIUS request) that is used to assign the temporary IP address. Then, the preference list stored in association with the identifier is retrieved from the database and transmitted to the web server. The web server uses the preferences to add the corresponding personalized information to the web site called up by the user. The web server can also be a server which is operated by the ISP itself and which maintains, for example, content to implement an access portal. According to one possible embodiment of the present invention, the explanations given at the outset can concern Internet advertising tailored to the specific interests of the user. For that purpose, the interests of the user are encoded in the preference list in a suitable manner.

At this point, it should be pointed out that, generally, the practical implementation of the method will surely take place with the consent of the user, or can easily be made dependent thereon by authorizing the ISP to store relevant preferences about the user's interests or the like; the authorization being given by the user by his/her signature to the corresponding general terms and conditions of business. In this connection, it should be noted that, while accessing the database of the ISP, the web server does not receive any personal user information, but only a list of suitably encoded preferences which could also apply to other users or a larger group of Internet users. Thus, data protection can be fully ensured in a very simple manner.

In a particularly advantageous embodiment of the method, even the portal page that appears on the user's terminal after dialing into the Internet is personalized using the preferences stored for the user. According to another particularly advantageous embodiment, the user has also the possibility to access the database of the ISP via the portal in order to change the preference list stored in association with him/her. This access can advantageously also be accomplished by using a reverse RADIUS request.

In a specific, practice-relevant embodiment, the method of the present invention includes the following method steps:
a) the user dialing into the Internet using a terminal suitable for this purpose (for example, a computer or a WAP cellular phone) by dialing into an access server of an ISP,
b) the user logging-on and authenticating to the access server,
c) assigning a temporary IP address to the terminal used for dial-in, or the browser running on this terminal, by using a RADIUS request,
d) the user entering the Internet address (IP address) by specifying the name of a web server or selecting a hyperlink,
e) routing the connection from the terminal used by the user to the web server,
f) calling up the desired web site from the web space of the web server,
g) the web server initiating a database request to the ISP, sending the temporary IP address of the terminal used for calling up the web site,
h) the access server of the ISP or a database server associated therewith carrying out a reverse RADIUS request to establish one or more identifiers of the user,
i) retrieving the preference list stored in the database of the ISP in association with the identifiers, and transmitting the preference list to the requesting web server,
j) the web server analyzing the preference list and supplementing the web site maintained for transmission to the user with personalized information that corresponds to the preferences,
k) transmitting the web site together with the personalized information to the terminal of the user.

User log-on and authentication during dial-up to the IP network can be carried out by different methods used for this purpose. Thus, in accordance with the present invention, this is done, for example, using the Password Authentication Protocol method (PAP). In the process, the access server or the database server associated therewith, which has been informed of the temporary IP address of the user during the database request, resolves the temporary IP address to a user name and, if applicable, a password via the reverse RADIUS request. Using this information (identity attributes) or a customer number corresponding thereto, the access server accesses the preference list stored in the database.

In another possible embodiment, user log-on and authentication during dial-up to the IP network is carried out using the Challenge and Response Authentication Protocol method (CHAP). In this case, the access server or the database server accesses the preference list stored in the database by a reverse RADIUS request using the CHAP method.

As already sufficiently explained, the method according to the present invention is, at its core, based on the use of the RADIUS request, which is anyway carried out during dial-up to the Internet, or, to be more precise, on the reversal thereof. While the web servers within the network are assigned fixed IP addresses at which they can be contacted by the users of the contents that are stored thereon, the users themselves are assigned a temporary IP address, but in each case only for the time during which they are online via a system of hardware and software that is suitable for this purpose. This takes place during dial-up to the Internet.

An expression used in connection with the dial-up is that the user “logs on”. In fact, the user must authenticate to the provider (Internet service provider—ISP), i.e., to its dial-in node or access server that physically allows the user to access the network. This is done in the manner mentioned earlier, mostly by entering a user name and a password. On this basis, using a standard procedure, namely the so-called “RADIUS request, the ISP or the system used by the ISP assigns the user an IP address which is valid for the duration of the online session and which, from a physical point of view, is the decisive recipient information for receiving information requested and transmitted over the network. In this connection, an entry recording the current association between the temporary IP address and specific customer data of the user is stored on the access server. Such a RADIUS user entry may look like this:

user_X Password=“abcde”, Caller-Id=“00402226778”

Ascend-Send-Auth=Send-Auth-PAP,
Framed-Protocol=PPP,
User-Service=Framed-User,
Framed-Address=141.45. 240.1.,
Framed-Netmask=255.255. 255.255,
Ascend-Metric=2,
Framed-Routing=None,
Ascend-Idle-Limit=720,
Ascend-Dial-Number=00402226778,
   the number of the line via which the dial-up is made often being also used as a customer number or at least being linked thereto. Now, it becomes clear that knowledge of the temporary IP address allows data (such as the caller ID as the call number of the user establishing the connection) that uniquely identifies the user (customer), i.e., which represent a user identity attribute, to be inferred from the temporary IP address by reasoning backward (which is therefore referred to as reverse RADIUS request herein).

A possible sequence of the method as perceived by an Internet user is described again below in the manner of an exemplary embodiment, but without illustrative drawings. By starting a browser on a terminal capable of using the Internet, the user connects to the access server of an ISP to which he/she must authenticate with personal information (such as user name, password), and on which relevant preferences of the user were previously stored (preferably with the authorization of the user). At the same time, due to a starting address preset in the browser or an address entered by the user using the TCP/IP, the user sends an http request for connection to a web server in order to call up a web site. The web server, whose operator makes use of the possibility of distributing personalized information, submits a database request to a server of the ISP unnoticed by the user in order to obtain the preferences stored for the user; the web server adding to the request the temporary IP address that is assigned to the user according to the RADIUS method. The preferences obtained as a result of a backward or reverse RADIUS request are transmitted by the ISP to the web server, also in the background and unnoticed by the user. The web server can use the preferences as a basis for supplementing the web site called up by the user with corresponding additional information. Thus, in addition the “normal” user interface of, for example, a search engine whose web site has been called up by a user, for example, information about special offers of specific computer vendors is displayed to the user. The user does not receive just any type of advertising, but is informed of products he/she is interested in and for which he/she has expressed his/her interest by specifying corresponding preferences.

The great advantage of this method is that it allows information which can be added to a web site as a variable component to be personalized down to the level of the individual user. This takes place without the active assistance of the user at the moment the user calls up the web site. However, due to the link to the preferences stored by the user in the database, the user receives only the information he/she wishes to receive. In an advantageous refinement of the method, the user is even able to change the relevant preferences at any time. From the point of view of the ISP, the advantage lies in the added value that can be obtained by selectively placing additional information, preferably advertising. The ISP itself can place personalized advertising, for example, using a web server of its own which maintains content to implement an access portal, or else participate in the placement of advertising by third parties (other web server operators) by charging for providing the user preference information from its database. This is ultimately a question of the terms and conditions of respective contracts.

The method has been described above mainly in the context of the placement of personalized advertising on web pages. However, it should be explicitly emphasized that other types of personalized information can also be transmitted along with the pages according to this principle, and that the present invention is therefore not limited to this use.

1-8. (canceled).

9. A method for outputting personalized information to an internet user calling up a web site, comprising:
storing, in a database associated with an access server of an internet service provider of the user, a list of preferences for the user in association with an identifier of the user;
requesting, from the internet service provider of the user using a database request, the list of preferences using a web server contacted by the user to call up a web site;
supplementing, by the web server, prior to sending the web page to a terminal used by the user to access the internet, the web site called up by the user with personalized information using at least one preference of the list of preferences from the database;
sending, by the web server, to the internet service provider, a temporary IP address of the terminal for the database request;
establishing the identifier of the user by reversing a remote authentication dial-in user service request used to assign the temporary IP address; and
transmitting the stored list of preferences to the web server.

10. The method as recited claim 9 wherein the list of preferences includes personal interests of the user.

11. The method as recited claim 9 wherein the identifier of the user includes a customer number of the user.

12. The method as recited claim 9 wherein the terminal is at least one of a computer and a telecommunications terminal.

13. The method as recited claim 9 wherein the remote authentication dial-in user service request is a RADIUS request.

14. The method as recited claim 9 wherein the web server is a web server of the internet service provider.

15. The method as recited in claim 9 wherein the personalized information is associated with advertising of the internet tailored to specific interests of the user, the specific interests being encoded in the list of preferences.

16. The method as recited in claim 9 further comprising personalizing, using the list of preferences, a portal page that appears on the terminal after a dialing into the internet.

17. The method as recited in claim 16 wherein the database is accessible by the user via the portal so as to enable the user to change the stored list of preferences.

18. The method as recited in claim 17 wherein an access of the database by the user for changing the list of preferences is performable using a reverse remote authentication dial-in user service request.

19. The method as recited in claim 9 wherein the requesting is performed by the web server, the establishing is performed by the access server or the database server associated therewith, and the remote authentication dial-in user service request is a RADIUS request, and further comprising:
dialing, by the user, into the internet using the terminal by dialing into an access server of the internet service provider;
logging-on and authenticating, by the user, to the access server;
assigning a temporary IP address to the terminal using the RADIUS request;
entering, by the user, an internet address by specifying a name of the web server or selecting a hyperlink;
routing a connection from the terminal to the web server;
calling up the web site from a web space of the web server;
retrieving the list of preference stored in the database of the internet service provider and transmitting the list to the web server;
analyzing, by the web server, the list of preferences; and
transmitting to the terminal the web site together with personalized information.

20. The method as recited in claim 19 wherein the internet address is an IP address.

21. The method as recited in claim 19 wherein:
the logging-on and authenticating is performed using a password authentication protocol process; and
the reversed RADIUS request is performed so as to resolves the temporary IP address to a user name of the user; and
the retrieving the list of preferences is performed using the user name of the user.

22. The method as recited in claim 21 wherein the reversed RADIUS request is performed so as to resolves the temporary IP address to a password.

23. The method as recited in claim 21 wherein the password authentication protocol process is a PAP process.

24. The method as recited in claim 19 wherein:
the logging-on and authenticating is performed using a challenge and response authentication protocol process; and
the retrieving the list of preferences is performed by the access server or the database server associated therewith accessing the list of preferences stored in the data base via the reversed RADIUS request using the challenge and response authentication protocol process and the temporary IP address.

25. The method as recited in claim 24 wherein the challenge and response authentication protocol process is a CHAP process.
